(19) United States
(12) Patent Application Publication
(10) Pub. No.: US 2024/0371121 A1
(43) Pub. Date: Nov. 7, 2024

(54) CONTROL APPARATUS, CONTROL METHOD, AND RECORDING MEDIUM

(71) Applicant: NEC Corporation, Minato-ku, Tokyo (JP)

(72) Inventor: Chisato FUNAYAMA, Tokyo (JP)

(73) Assignee: NEC Corporation, Minato-ku, Tokyo (JP)

(21) Appl. No.: 18/272,276

(22) PCT Filed: Jul. 9, 2021
(86) PCT No.: PCT/JP2021/025994

§ 371 Date: Jul. 13, 2023

(51) Int. Cl. G06V 10/141; G06V 40/16; G06V 40/18

(52) U.S. Cl. CPC G06V 10/141; G06V 40/172; G06V 40/18

(57) ABSTRACT

A control apparatus includes: an acquisition unit that obtains a face image including a face area of an authentication target; a calculation unit that calculates information about luminance of each of a plurality of areas in the face area; and an output unit that outputs a control parameter for controlling a lighting unit that applies an illumination light when the face image is captured, on the basis of the information about the luminance. According to such a control apparatus, it is possible to output information required for an appropriate optical environment when the face image of the user is captured.

### TECHNICAL FIELD

This disclosure relates to technical fields of a control apparatus, a control method, and a recording medium.

### BACKGROUND ART

An apparatus that performs a control related to lighting when a face image is captured, is known as this type of apparatus. For example, Patent Literature 1 discloses a technique/technology of changing illumination intensity on the basis of a luminance value distribution of a background image. Patent Literature 2 discloses a technique/technology of adjusting the brightness of an eye part to be proper, in order to reduce an influence of reflection and appearance on the eyeglasses.

As another related technology, Patent Literature 3 discloses a technique/technology of calculating a histogram of a luminance value from a face area and of calculating a corrected luminance value from an average luminance value of the face area.

### CITATION LIST

### Patent Literature

Patent Literature 1: JP2005-165943A
Patent Literature 2: JP2009-116797A
Patent Literature 3: JP2006-018465A

### SUMMARY

### Technical Problem

This disclosure aims to improve the techniques/technologies disclosed in Citation List.

### Solution to Problem

A control apparatus according to an example aspect of this disclosure includes: an acquisition unit that obtains a face image including a face area of an authentication target; a calculation unit that calculates information about luminance of each of a plurality of areas in the face area; and an output unit that outputs a control parameter for controlling a lighting unit that applies an illumination light when the face image is captured, on the basis of the information about the luminance.

A control method according to an example aspect of this disclosure includes: obtaining a face image including a face area of an authentication target; calculating information about luminance of each of a plurality of areas in the face area; and outputting a control parameter for controlling a lighting unit that applies an illumination light when the face image is captured, on the basis of the information about the luminance.

A recording medium according to an example aspect of this disclosure is a recording medium on which a computer program that allows at least one computer to execute a control method is recorded, the control method including: obtaining a face image including a face area of an authentication target; calculating information about luminance of each of a plurality of areas in the face area; and outputting a control parameter for controlling a lighting unit that applies an illumination light when the face image is captured, on the basis of the information about the luminance.

### BRIEF DESCRIPTION OF DRAWINGS

FIG. 1 is a block diagram illustrating a hardware configuration of a control apparatus according to a first example embodiment.

FIG. 2 is a block diagram illustrating a functional configuration of the control apparatus according to the first example embodiment.

FIG. 3 is a flowchart illustrating a flow of operation of the control apparatus according to the first example embodiment.

FIG. 4 is a block diagram illustrating a functional configuration of a control apparatus according to a second example embodiment.

FIG. 5 is a flowchart illustrating a flow of the operation of the control apparatus according to the second example embodiment.

FIG. 6 is a block diagram illustrating a functional configuration of a control apparatus according to a third example embodiment.

FIG. 7 is a block diagram illustrating a functional configuration of a control apparatus according to a fourth example embodiment.

FIG. 8 is a plan view illustrating an example of an area in which a luminance value of the control apparatus according to the fourth example embodiment is detected.

FIG. 9 is a block diagram illustrating a functional configuration of a control apparatus according to a fifth example embodiment.

FIG. 10 is a flowchart illustrating a flow of operation of the control apparatus according to the fifth example embodiment.

FIG. 11 is a block diagram illustrating a functional configuration of a control apparatus according to a sixth example embodiment.

FIG. 12 is a flowchart illustrating a flow of operation of the control apparatus according to the sixth example embodiment.

FIG. 13 is a block diagram illustrating a functional configuration of a control apparatus according to a seventh example embodiment.

FIG. 14 is a flowchart illustrating a flow of operation of the control apparatus according to the seventh example embodiment.

FIG. 15A to FIG. 15C are plan views illustrating a calculation example of a luminance difference in the control apparatus according to the seventh example embodiment.

FIG. 16A to FIG. 16C are plan views illustrating a calculation example of a change amount of luminance in the control apparatus according to the seventh example embodiment.

FIG. 17 is a block diagram illustrating a functional configuration of a control apparatus according to an eighth example embodiment.

FIG. 18 is a flowchart illustrating a flow of operation of the control apparatus according to the eighth example embodiment.

FIG. 19 is a conceptual diagram illustrating an estimation example of a luminance distribution in the control apparatus according to the eighth example embodiment.

FIG. 20 is a block diagram illustrating a functional configuration of a control apparatus according to a ninth example embodiment.

FIG. 21 is a flowchart illustrating a flow of operation of the control apparatus according to the ninth example embodiment.

FIG. 22 is a conceptual diagram illustrating a control example of a lighting by the control apparatus according to the ninth example embodiment.

FIG. 23 is a plan view illustrating a configuration and an operation example of a control apparatus according to a tenth example embodiment.

FIG. 24 is a plan view illustrating a configuration and an operation example of a control apparatus according to an eleventh example embodiment.

FIG. 25 is a block diagram illustrating a configuration of a control apparatus according to a twelfth example embodiment.

### DESCRIPTION OF EXAMPLE EMBODIMENTS

Hereinafter, a control apparatus, a control method, and a recording medium according to example embodiments will be described with reference to the drawings.

### First Example Embodiment

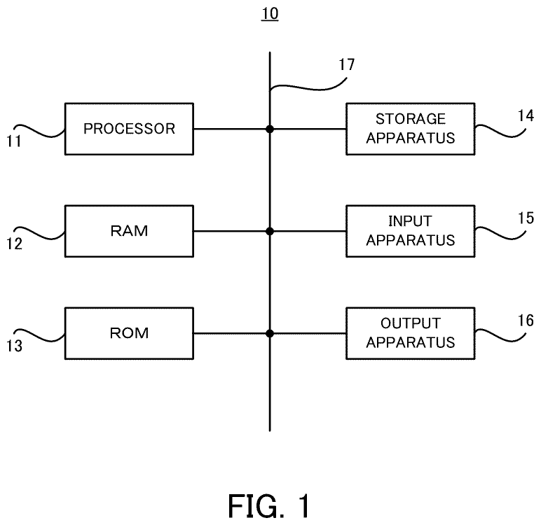

A control apparatus according to a first example embodiment will be described with reference to FIG. 1 to FIG. 3.

### (Hardware Configuration)

First, with reference to FIG. 1, a hardware configuration of the control apparatus according to the first example embodiment will be described. FIG. 1 is a block diagram illustrating the hardware configuration of the control apparatus according to the first example embodiment.

As illustrated in FIG. 1, a control apparatus 10 according to the first example embodiment includes a processor 11, a RAM (Random Access Memory) 12, a ROM (Read Only Memory) 13, and a storage apparatus 14. The control apparatus 10 may further include an input apparatus 15 and an output apparatus 16. The processor 11, the RAM 12, the ROM 13, the storage apparatus 14, the input apparatus 15 and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., read) a computer program from a not-illustrated apparatus disposed outside the control apparatus 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for outputting a parameter for controlling a lighting is realized or implemented in the processor 11.

The processor 11 may be configured as, for example, a CPU (Central Process Unit), a GPU (Graphics Process Unit), a FPGA (field-programmable gate array), a DSP (Demand-Side Platform) or an ASIC (Application Specific Integrated Circuit). The processor 11 may include one of them, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the control apparatus 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the control apparatus 10. The input apparatus 15 may include, for example, at least one of a keyboard, a mouse, and a touch panel.

The output apparatus 16 is an apparatus that outputs information about the control apparatus 10 to the outside. For example, the output apparatus 16 may be a display apparatus (e.g., a display, a speaker, or the like) that is configured to display the information about the control apparatus 10.

### (Functional Configuration)

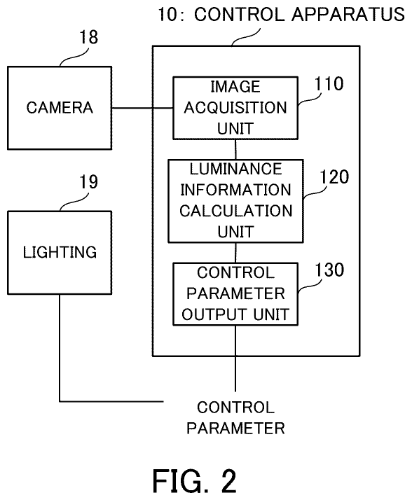

Next, with reference to FIG. 2, a functional configuration of the control apparatus 10 according to the first example embodiment will be described. FIG. 2 is a block diagram illustrating the functional configuration of the control apparatus according to the first example embodiment.

As illustrated in FIG. 2, the control apparatus 10 according to the first example embodiment is configured to control a camera 18 and a lighting 19. Here, illustrated is the configuration in which the camera 18 and the lighting 19 are provided separately from the control apparatus 10, but the control apparatus 10 may be configured as a system including the camera 18 and the lighting 19 as components thereof. The control apparatus 10 includes, as process blocks for realizing the functions thereof, an image acquisition unit 110, a luminance information calculation unit 120, and a control parameter output unit 130. Each of the image acquisition unit 110, the luminance information calculation unit 120, and the control parameter output unit 130 may be realized or implemented by the processor 11 (see FIG. 1), for example.

The image acquisition unit 110 is configured to obtain a face image (an image including a face area) of a user (an authentication target) imaged by the camera 18. The face image of the user obtained by the image acquisition unit 110 is configured to be outputted to the luminance information calculation unit 120.

The luminance information calculation unit 120 is configured to calculate information about luminance of the face area in the image obtained by the image acquisition unit 110. Here, the “information about the luminance” may be information indicating the luminance itself (i.e., a luminance value), or may be information calculated by using the luminance. In the following, the information about the luminance is referred to as a “luminance information” as appropriate. A specific example of the luminance information will be described in detail in another example embodiment described later. In particular, the luminance information calculation unit 120 is configured to calculate the luminance information for each of a plurality of areas in the face area. For example, the luminance information calculation unit 120 may divide the face area into a plurality of areas and may calculate the luminance information for each area. The division of the face area will be described in detail in another example embodiments described later. The luminance information calculated by the luminance information calculating unit 120 is configured to be outputted to the control parameter output unit 130.

The control parameter output unit 130 is configured to output a control parameter for controlling the lighting 19 on the basis of the luminance information calculated by the luminance information calculating unit 120. The control parameter is a parameter for changing a degree to which the user is exposed to the lighting 19, and may be a parameter for turning on and off the lighting 19, for adjusting the illuminance of the lighting 19, and adjusting the direction of the lighting 19, for example. When a part of the face area is dark (i.e., the luminance is low), the control parameter output unit 130 may output a control parameter for controlling the lighting 19 to brighten the dark area, for example. When a part of the face area is bright (i.e., the luminance is high), the control parameter output unit 130 may output a control parameter for controlling the lighting 19 to brighten the area. The control parameter may be outputted from the output apparatus 16 (specifically, a display, a speaker, or the like), for example.

In this case, the lighting 19 may be manually adjusted on the basis of the outputted control parameter. Alternatively, the control parameter may be outputted as a control parameter of an apparatus that are configured to control the lighting 19. In this case, the lighting 19 may be controlled automatically in accordance with the control parameter.

### (Flow of Operation)

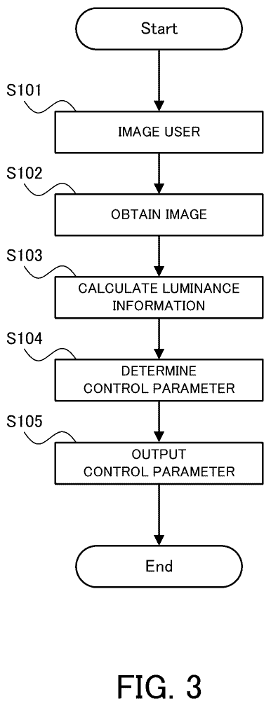

Next, with reference to FIG. 3, a flow of operation of the control apparatus 10 according to the first example embodiment will be described. FIG. 3 is a flowchart illustrating the flow of the operation of the control apparatus according to the first example embodiment.

As illustrated in FIG. 3, in operation of the control apparatus 10 according to the first example embodiment, first, the camera 18 captures the face image of the user (step S101). The image acquisition unit 110 obtains the face image of the user captured by the camera 18 (step S102).

Subsequently, the luminance information calculation unit 120 calculates the luminance information for each of the plurality of areas in the face area, from the face image of the user captured by the image acquisition unit 110 (step S103).

Subsequently, the control parameter output unit 130 determines the control parameter to be outputted, on the basis of the luminance information calculated by the luminance information calculation unit 120 (step S104). Then, the control parameter output unit 130 outputs the determined control parameter (step S105).

### (Technical Effect)

Next, a technical effect obtained by the control apparatus 10 according to the first example embodiment will be described.

As described in FIG. 1 to FIG. 3, in the control apparatus 10 according to the first example embodiment, the control parameter for controlling the lighting is outputted on the basis of the luminance information calculated for each of the plurality of areas in the face area. In this way, it is possible to improve an imaging environment of the image of the user, by controlling the lighting in accordance with the control parameter. Therefore, for example, it is possible to properly perform face authentication of the user.

### Second Example Embodiment

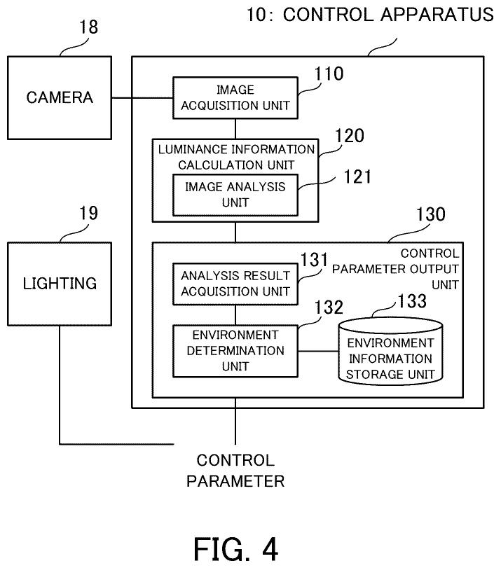

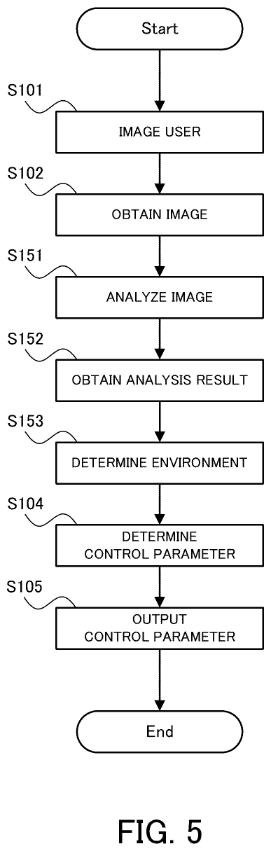

The control apparatus 10 according to a second example embodiment will be described with reference to FIG. 4 and FIG. 5. The second example embodiment is partially different from the first example embodiment only in the configuration and operation, and may be the same as the first example embodiment in the other parts. For this reason, a part that is different from the first example embodiment described above will be described in detail below, and a description of other overlapping parts will be omitted as appropriate.

### (Functional Configuration)

First, with reference to FIG. 4, a functional configuration of the control apparatus 10 according to the second example embodiment will be described. FIG. 4 is a block diagram illustrating the functional configuration of the control apparatus according to the second example embodiment. In FIG. 4, the same components as those illustrated in FIG. 2 carry the same reference numerals.

As illustrated in FIG. 4, the control apparatus 10 according to the second example embodiment includes, as process blocks for realizing the functions thereof, the image acquisition unit 110, the luminance information calculation unit 120, and the control parameter output unit 130. In particular, the luminance information calculation unit 120 according to the second example embodiment includes an image analysis unit 121. The control parameter output unit 130 according to the second example embodiment includes an analysis result acquisition unit 131, an environment determination unit 132, and an environment information storage unit 133.

The image analysis unit 121 is configured to perform an analysis process on the face image of the user obtained by the image acquisition unit 110. This analysis process is a process for calculating the luminance information of the face area of the user. A detailed description of an analysis method for calculating the luminance information will be omitted here, because the existing techniques/technologies can be adopted to the method as appropriate.

The analysis result acquisition unit 131 is configured to obtain an analysis result (i.e., the luminance information) of the image analysis unit 121. The luminance information obtained by the analysis result acquisition unit 131 is configured to be outputted to the environmental determination unit 132.

The environment determination unit 132 is configured to determine whether or not the imaging environment is appropriate, on the basis of the luminance information obtained by the analysis result acquisition unit 131. More specifically, the environment determination unit 132 determines whether or not the luminance information satisfies a predetermined condition. The “predetermined condition” here is a condition set to determine whether or not the imaging environment is appropriate, and may be a threshold for determining whether or not the luminance value is sufficiently high, for example.

The environment information storage unit 133 is configured to store information indicating the predetermined condition used by the environment determination unit 132 (e.g., a threshold, etc.). The information stored in the environment information storage unit 133 is configured to be read by the environment determination unit 132 as appropriate.

### (Flow of Operation)

Next, with reference to FIG. 5, a flow of operation of the control apparatus 10 according to the second example embodiment will be described. FIG. 5 is a flowchart illustrating the flow of the operation of the control apparatus according to the second example embodiment. In FIG. 5, the same steps as those illustrated in FIG. 3 carry the same reference numerals.

As illustrated in FIG. 5, in operation of the control apparatus 10 according to the second example embodiment, first, the camera 18 captures the face image of the user (step S101). The image acquisition unit 110 obtains the face image of the user captured by the camera 18 (step S102).

Subsequently, the image analysis unit 121 performs the analysis process on the face image of the user captured by the image acquisition unit 110, and calculates the luminance information for each of the plurality of areas in the face area (step S151). Then, the analysis result acquisition unit 131 obtains the luminance information calculated by the image analysis unit 121 (step S152).

Subsequently, the environment determination unit 132 determines whether or not the imaging environment is appropriate, on the basis of the luminance information obtained by the analysis result acquisition unit 131 and the information read from the environment information storage unit 133 (step S153). Then, the control parameter output unit 130 determines the control parameter in accordance with a determination result of the environmental determination unit 132 (step S104), and outputs the determined control parameter (step S105).

When the determination result of the environment determination unit 132 indicates that the control of the lighting 19 is not required (e.g., when the imaging environment is already appropriate without controlling the lighting 19), the steps S104 and S105 may be omitted. That is, when there is no need to control the lighting, the control parameter may not be outputted.

### (Technical Effect)

Next, a technical effect obtained by the control apparatus 10 according to the second example embodiment will be described.

As described in FIG. 4 and FIG. 5, in the control apparatus 10 according to the second example embodiment, the control parameter is outputted on the basis of the determination result of the imaging environment. In this way, it is possible to properly improve the imaging environment of the image of the user.

### Third Example Embodiment

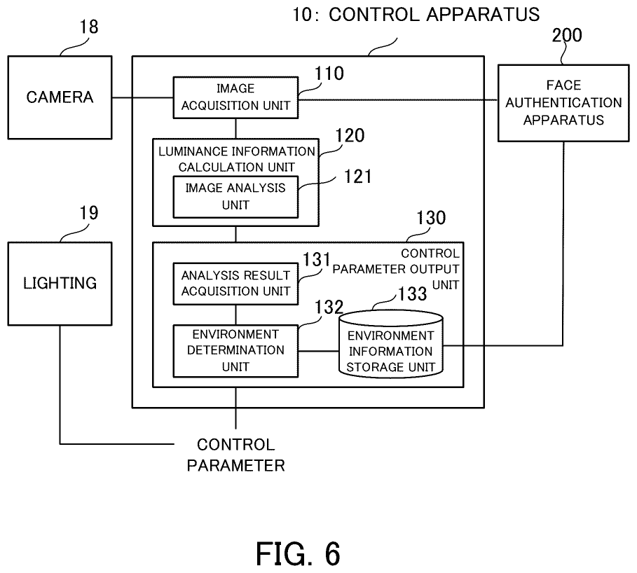

The control apparatus 10 according to a third example embodiment will be described with reference to FIG. 6. The third example embodiment is partially different from the second example embodiment only in the configuration and operation, and may be the same as the first or second example embodiment in the other parts. For this reason, a part that is different from each of the example embodiments described above will be described in detail below, and a description of other overlapping parts will be omitted as appropriate.

### (Functional Configuration)

First, with reference to FIG. 6, a functional configuration of the control apparatus 10 according to the third example embodiment will be described. FIG. 6 is a block diagram illustrating the functional configuration of the control apparatus according to the third example embodiment. In FIG. 6, the same components as those illustrated in FIG. 4 carry the same reference numerals.

As illustrated in FIG. 6, the control apparatus 10 according to the third example embodiment includes, as process blocks for realizing the functions thereof, the image acquisition unit 110, the luminance information calculation unit 120, and the control parameter output unit 130. In particular, the control apparatus 10 according to the third example embodiment is connected to a face authentication apparatus 200, in addition to the camera 18 and the lighting 19. The function of the face authentication apparatus 200 may be realized or implemented by the control apparatus 10. That is, the control apparatus 10 may include the face authentication apparatus 200.

The face authentication apparatus 200 is configured to perform the face authentication of the user by using the face image of the user obtained by the image acquisition unit 110 (i.e., the image captured by the camera 18). A detailed description of a specific method of the face authentication will be omitted here, because the existing techniques/technologies can be adopted to the method as appropriate.

In particular, the face authentication apparatus 200 according to this example embodiment has a function of storing information obtained by performing the face authentication, in the environmental information storage unit 133, in addition to a function of performing the face authentication. Specifically, the face authentication apparatus 200 is configured to accumulate, in the environmental information storage unit 133, information about the face image when the face authentication can be accurately performed.

As described above, the environmental information storage unit 133 according to this example embodiment stores the information about the face image when the face authentication can be accurately performed. Therefore, the information about the predetermined condition stored in the environment information storage unit 133 corresponds to the environment in which the face authentication can be accurately performed. Consequently, the environment determination unit 132 determines whether or not the imaging environment is an environment suitable for the face authentication.

### (Technical Effect)

Next, a technical effect obtained by the control apparatus 10 according to the third example embodiment will be described.

As described in FIG. 6, in the control apparatus 10 according to the third example embodiment, it is determined whether or not the imaging environment is suitable for the face authentication, and the lighting 19 is controlled accordingly. In this way, since the imaging environment is adjusted into a condition suitable for the face authentication by the control of the lighting 19, it is possible to prevent a reduction in the accuracy of the face authentication due to the imaging environment. In addition, since the face authentication is mechanically performed by the face authentication apparatus 200, it is hard to determine what type of face image is suitable for the face authentication, with human eyes. Therefore, the technical effect of this example embodiment that the imaging environment suitable for the face authentication can be automatically realized, is extremely beneficial.

### Fourth Example Embodiment

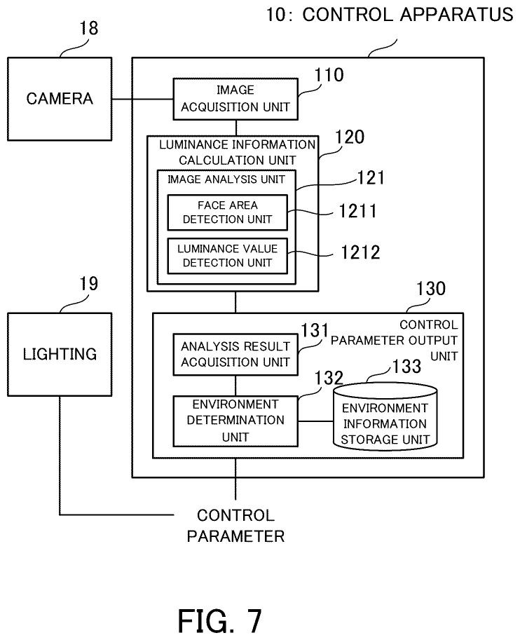

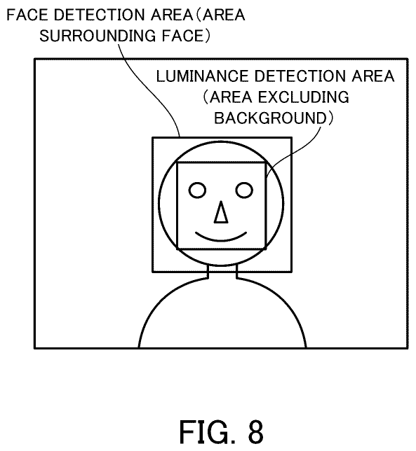

The control apparatus 10 according to a fourth example embodiment will be described with reference to FIG. 7 and FIG. 8. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Functional Configuration)

First, with reference to FIG. 7, a functional configuration of the control apparatus 10 according to the fourth example embodiment will be described. FIG. 7 is a block diagram illustrating the functional configuration of the control apparatus according to the fourth example embodiment. In FIG. 7, the same components as those illustrated in FIG. 4 carry the same reference numerals.

As illustrated in FIG. 7, the control apparatus 10 according to the fourth example embodiment includes, as process blocks for realizing the functions thereof, the image acquisition unit 110, the luminance information calculation unit 120, and the control parameter output unit 130. In particular, the image analysis unit 121 according to the fourth example embodiment includes a face area detection unit 1211 and a luminance value detection unit 1212.

The face area detection unit 1211 is configured to detect the face area in which the face of the user is positioned, from the face image of the user. A detailed description of a specific method of detecting the face area will be omitted here, because the existing techniques/technologies can be adopted to the method as appropriate. Information about the face area detected by the face area detection unit 1211 is configured to be outputted to the luminance value detection unit 1212.

The luminance value detection unit 1212 is configured to detect the luminance value from the face area detected by the face area detection unit 1211. The luminance value detection unit 1212 may detect the luminance values of the respective pixels of the face area. The luminance value detection unit 1212 may detect an average value of the luminance values detected from the pixels of the face area, as an average luminance value. The image analysis unit 121 according to this example embodiment outputs the luminance value obtained in this manner from the face area, as an analysis result (i.e., the luminance information). As described below, the area detected by the face area detection unit 1211 and the area for detecting the luminance value, may not be completely the same area.

### (Specific Operation Example)

Next, a specific operation example of the face area detection unit 1211 and the luminance value detection unit 1212 will be described with reference to FIG. 8. FIG. 8 is a plan view illustrating an example of the area for detecting the luminance value in the control apparatus according to the fourth example embodiment.

As illustrated in FIG. 8, the face area detection unit 1211 detects a rectangular area surrounding the face of the user, as the face area (hereinafter referred to as a “face detection area” as appropriate). The face detection area includes a background part in addition to the face of the user, because it is detected to include the whole face of the user. Therefore, if the luminance value is detected from the face detection area, it includes the luminance value of the background.

In order to avoid the above problem, the luminance value detection unit 1212 detects the luminance value from a narrower area than the face area detected by the face area detection unit 1211 (hereinafter referred to as a “luminance detection area” as appropriate). The luminance detection area is an area with a size smaller than that of the face area detected by the face area detection unit 1211, and does not include the background (the whole area is the face of the user). Therefore, the luminance value detected from the luminance detection area is information indicating the brightness of the face of the user, more accurately.

The luminance detection area may be calculated in accordance with a ratio (a ratio of the luminance detection area to the face detection area) set in advance.

### (Technical Effect)

Next, a technical effect obtained by the control apparatus 10 according to the fourth example embodiment will be described.

As described in FIG. 7 and FIG. 8, in the control apparatus 10 according to the fourth example embodiment, the face area is detected from the face image of the user, and the luminance value of the face area (or an area included in the face area) is detected. In this way, since the brightness of the face of the user can be properly detected, it is possible to properly perform the determination related to the imaging environment.

### Fifth Example Embodiment

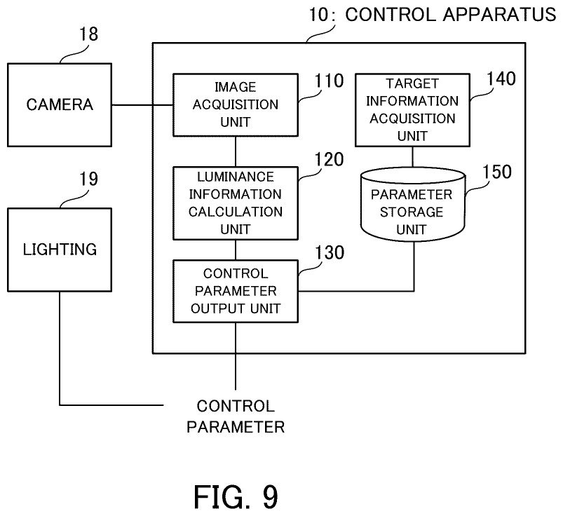

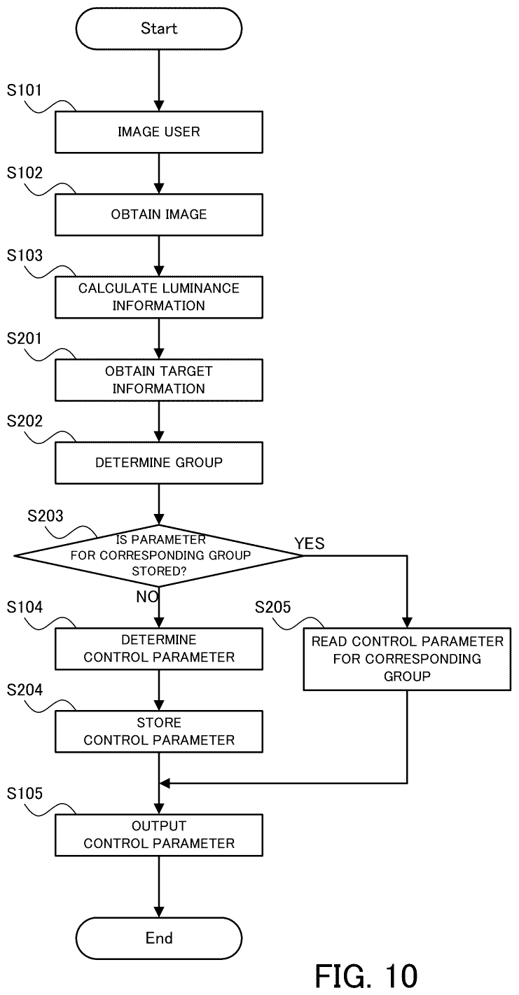

The control apparatus 10 according to a fifth example embodiment will be described with reference to FIG. 9 and FIG. 10. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of other overlapping parts will be omitted as appropriate.

### (Functional Configuration)

First, with reference to FIG. 9, a functional configuration of the control apparatus 10 according to the fifth example embodiment will be described. FIG. 9 is a block diagram illustrating the functional configuration of the control apparatus according to the fifth example embodiment. In FIG. 9, the same components as those illustrated in FIG. 2 carry the same reference numerals.

As illustrated in FIG. 9, the control apparatus 10 according to the fifth example embodiment includes. as process blocks for realizing the functions thereof, the image acquisition unit 110, the luminance information calculation unit 120, the control parameter output unit 130, a target information acquisition unit 140, and a parameter storage unit 150. That is, the control apparatus 10 according to the fifth example embodiment further includes the target information acquisition unit 140 and the parameter storage unit 150, in addition to the configuration in the first example embodiment (see FIG. 2). The target information acquisition unit 140 may be realized or implemented by the processor 11 (see FIG. 1), for example. The parameter storage unit 150 may be realized or implemented by the storage apparatus 14 (see FIG. 1), for example.

The target information acquisition unit 140 is configured to obtain information about the user (i.e., the authentication target) (hereinafter referred to as a “target information” as appropriate). The “target information” here includes at least one information about the authentication target, and an example thereof includes information about a personal ID of the user, information about physical features of the user, and the like. The target information acquisition unit 140 may be configured to obtain the target information from the image of the user captured by the camera 18. Alternatively, the target information acquisition unit 140 may be configured to obtain the target information by means other than the camera 140 (e.g., various sensors, etc.).

In addition, the target information acquisition unit 140 is configured to determine a predetermined group to which the user belongs, on the basis of the target. Examples of the predetermined group are a group according to the personal ID, a group according to the shape of the face (e.g., a group of people with a shapely sculpted face, a group of people with a flat nose, etc.), a group according to the brightness of a skin (e.g., a group of people with the skin brightened, a group of people with the skin shaded, etc.), and a group according to an eye color (e.g., a group of people with a light eye color, a group of people with a dark eye color, etc.). Information about the group to which the user belongs determined by the target information acquisition unit 140 is configured to be outputted to the parameter storage unit 150.

The parameter storage unit 150 is configured to store the predetermined group to which the user belongs, in association with the control parameter determined from the face image of the user. For example, when it is determined that the user is classified into the group of people with the skin brightened, the parameter storage unit 150 may store the control parameter corresponding to the user, in association with the group of people with the skin brightened. The control parameter for each group stored in the parameter storage unit 150 may be readable by the control parameter output unit 130 as appropriate.

### (Flow of Operation)

Next, with reference to FIG. 10, a flow of operation of the control apparatus 10 according to the fifth example embodiment will be described. FIG. 10 is a flowchart illustrating the flow of the operation of the control apparatus according to the fifth example embodiment. In FIG. 10, the same steps as those illustrated in FIG. 3 carry the same reference numerals.

As illustrated in FIG. 10, in operation of the control apparatus 10 according to the fifth example embodiment operates, first, the camera 18 captures the face image of the user (step S101). The image acquisition unit 110 obtains the face image of the user captured by the camera 18 (step S102). Subsequently, the luminance information calculation unit 120 calculates the luminance information for each of the plurality of areas in the face area, from the face image of the user captured by the image acquisition unit 110 (step S103).

Subsequently, the target information acquisition unit 140 obtains the target information from the user (step S201). Then, the target information acquisition unit 140 determines the group to which the user belongs, on the basis of the obtained target information (step S202).

Subsequently, the parameter storage unit 150 determines whether or not the control parameter is stored in association with the group to which the user belongs (step S203). When the control parameter is not stored in association with the group to which the user belongs (step S203: NO), the control parameter output unit 130 determines the control parameter on the basis of the luminance information obtained from the image of the user (step S104). Then, the parameter storage unit 150 stores the determined control parameters in association with the group to which the user belongs (step S204). In this case, the control parameter output unit 130 outputs the control parameter that is determined on the basis of the luminance information (step S105).

On the other hand, when the control parameter is stored in association with the group to which the user belongs (step S203: YES), the control parameter output unit 130 reads the control parameter stored in association with the group to which the user belongs, from the parameter storage unit 150 (step S205). In this case, the control parameter is determined, on the basis of the luminance information obtained from the image of the user (step S104). Then, the control parameter output unit 130 outputs the control parameter that is read from the parameter storage unit 150 (step S105).

### (Technical Effect)

Next, a technical effect obtained by the control apparatus 10 according to the fifth example embodiment will be described.

As described in FIG. 9 and FIG. 10, in the control apparatus 10 according to the fifth example embodiment, when the control parameter is stored in association with the group to which the user belongs, the stored control parameter is outputted. In this way, since a process of determining a new control parameter on the basis of the luminance information can be omitted depending on the circumstances, it is possible to simplify and speed up a process of outputting the control parameter. Therefore, it is possible to perform the control of the lighting 19 in accordance with the control parameters, more quickly.

### Sixth Example Embodiment

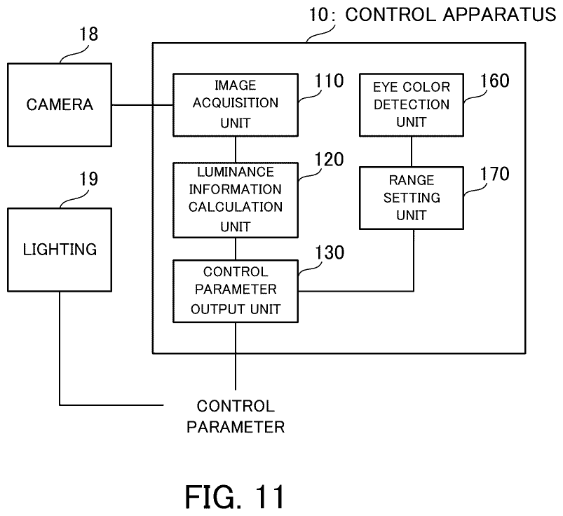

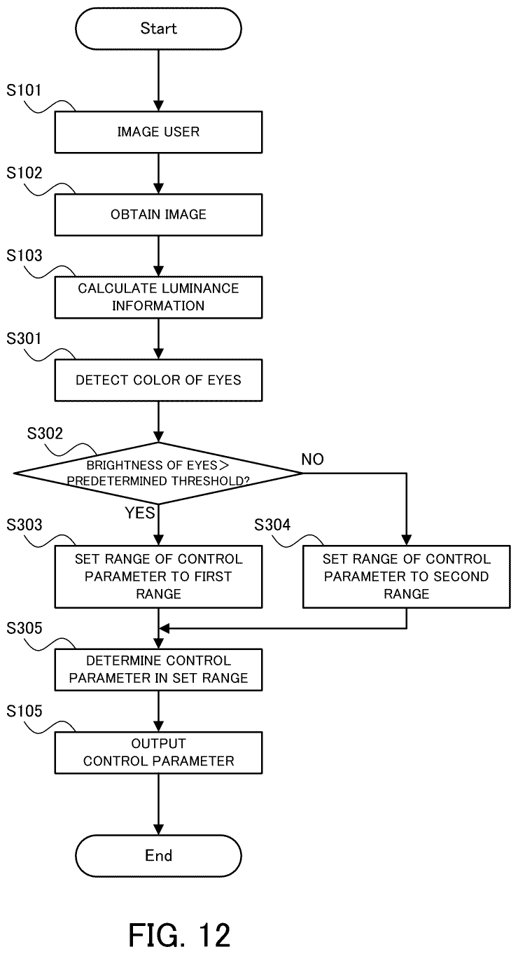

The control apparatus 10 according to a sixth example embodiment will be described with reference to FIG. 11 and FIG. 12. The sixth example embodiment is partially different from the first to fifth example embodiments only in the configuration and operation, and may be the same as the first to fifth example embodiments in the other parts. For this reason, a part that is different from each of the example embodiments described above will be described in detail below, and a description of other overlapping parts will be omitted as appropriate.

### (Functional Configuration)

First, with reference to FIG. 11, a functional configuration of the control apparatus 10 according to the sixth example embodiment will be described. FIG. 11 is a block diagram illustrating the functional configuration of the control apparatus according to the sixth example embodiment. In FIG. 11, the same components as those illustrated in FIG. 2 carry the same reference numerals.

As illustrated in FIG. 11, the control apparatus 10 according to the sixth example embodiment includes, as process blocks for realizing the functions thereof, the image acquisition unit 110, the luminance information calculation unit 120, the control parameter output unit 130, an eye color detection unit 160, and a range setting unit 170. That is, the control apparatus 10 according to the sixth example embodiment further includes the eye color detection unit 160 and the range setting unit 170, in addition to the configuration in the first example embodiment (refer to FIG. 2). Each of the eye color detection unit 160 and the range setting unit 170 may be realized or implemented by the processor 11 (see FIG. 1), for example.

The eye color detection unit 160 is configured to detect an eye color of the user. The eye color detection unit 160 may be configured to detect the eye color of the user from the face image of the user, or may be configured to detect the eye color of the user by using other means (e.g., an image captured by another camera). The eye color detection unit 160 may be configured to detect not a specific hue of the eye color of the user, but the brightness of the eyes (in other words, the amount of pigments). A detailed description of a specific method of detecting the eye color will be omitted here, because the existing techniques/technologies can be adopted to the method as appropriate. Information about the eye color detected by the eye color detection unit 160 is configured to be outputted to the range setting unit 170.

The range setting unit 170 is configured to set a range of the control parameter, on the basis of the eye color of the user detected by the eye color detection unit 160. Specifically, the range setting unit 170 sets the range of the control parameter to a first range when the eye color of the user is brighter than a predetermined threshold, and sets the range of the control parameter to a second range that is different from the first range, when the eye color of the user is darker than the predetermined threshold. In this case, the first range may be a range of the control parameter corresponding to a relatively dark illumination. The second range may be a range of the control parameter corresponding to a relatively bright illumination. The “range of the control parameter” determined by the range setting unit 170 is a range when the control parameter output unit 130 determines the control parameter on the basis of the luminance information. Therefore, the control parameter output unit 130 determines the control parameter to be in the range of the control parameter determined by range setting unit 170.

### (Flow of Operation)

Next, with reference to FIG. 12, a flow of operation of the control apparatus 10 according to the sixth example embodiment will be described. FIG. 12 is a flowchart illustrating the flow of the operation of the control apparatus according to the sixth example embodiment. In FIG. 12, the same steps as those illustrated in FIG. 3 carry the same reference numerals.

As illustrated in FIG. 12, in operation of the control apparatus 10 according to the sixth example embodiment, first, the camera 18 captures the face image of the user (step S101). The image acquisition unit 110 obtains the face image of the user captured by the camera 18 (step S102). Subsequently, the luminance information calculation unit 120 calculates the luminance information for each of the plurality of areas in the face area, from the face image of the user captured by the image acquisition unit 110 (step S103).

Subsequently, the eye color detection unit 160 detects the eye color of the user (step S301).

Then, the range setting unit 170 determines whether or not the eye color of the user detected by the eye color detection unit 160 is greater (in other words, brighter) than the predetermined threshold (step S302). When the eye color of the user is brighter than the predetermined threshold (step S302: YES), the range setting unit 170 sets the range of the control parameter to the first range (step S303). On the other hand, when the eye color of the user is darker than the predetermined threshold (step S302: NO), the range setting unit 170 sets the range of the control parameter to the second range (step S304).

Subsequently, the control parameter output unit 130 determines the control parameter to be outputted in the set range (i.e., in the first range or in the second range), on the basis of the luminance information calculated by the luminance information calculation unit 120 (step S305). Then, the control parameter output unit 130 outputs the determined control parameter (step S105).

The above example exemplifies a configuration in which the range setting unit 170 sets two types of ranges in accordance with the eye color of the user, but the range setting unit 170 may be configured to set three or more types of ranges. For example, the control range of the control parameter may be set to the first range when the user has a light eye color, to the second range when the user has a moderate eye color (i.e., an intermediate between light and dark), and to a third range when the user has a dark eye color.

### (Technical Effect)

Next, a technical effect obtained by the control apparatus 10 according to the sixth example embodiment will be described.

As described in FIG. 11 and FIG. 12, in the control apparatus 10 according to the sixth example embodiment, the range of the control parameter is set in accordance with the eye color of the user. In particular, it is known that there are individual differences in sensitivity to light depending on the eye color (e.g., a person with a lighter eye color is more sensitive to light). Therefore, by setting the range of the control parameter in accordance with the eye color, it is possible to properly control the lighting 19 in accordance with the sensitivity to light. For example, when the user has a light eye color, the lighting 19 may be controlled not to be too bright so that the user is not dazzled.

### Seventh Example Embodiment

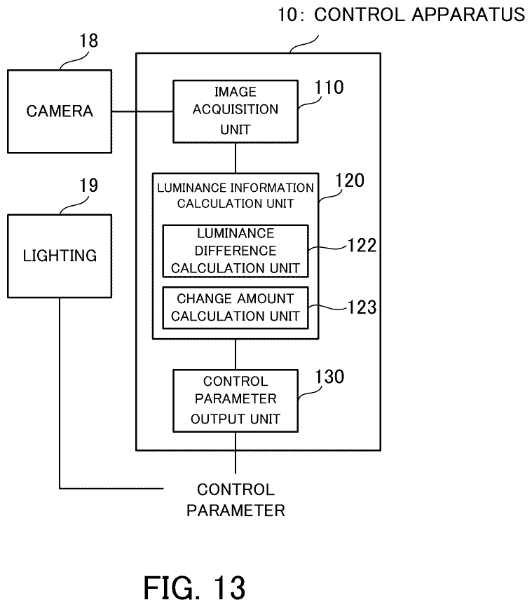

The control apparatus 10 according to a seventh example embodiment will be described with reference to FIG. 13 to FIG. 16C. The seventh example embodiment is partially different from the first to sixth example embodiments only in the configuration and operation, and may be the same as the first to sixth example embodiments in the other parts. For this reason, a part that is different from each of the example embodiments described above will be described in detail below, and a description of other overlapping parts will be omitted as appropriate.

### (Functional Configuration)

First, with reference to FIG. 13, a functional configuration of the control apparatus 10 according to the seventh example embodiment will be described. FIG. 13 is a block diagram illustrating the functional configuration of the control apparatus according to the seventh example embodiment. In FIG. 13, the same components as those illustrated in FIG. 2 carry the same reference numerals.

As illustrated in FIG. 13, the control apparatus 10 according to the seventh example embodiment includes, as process blocks for realizing the functions thereof, the image acquisition unit 110, the luminance information calculation unit 120, and the control parameter output unit 130. In particular, the luminance information calculation unit 120 according to the seventh example embodiment includes a luminance difference calculation unit 122 and a change amount calculation unit 123.

The luminance difference calculation unit 122 is configured to calculate a difference in the luminance of each of the plurality of areas (hereinafter referred to as a “luminance difference”), from the face image of the user. The luminance difference calculation unit 122 calculates the luminance value for each of the plurality of areas in the face area, and calculates a difference in the luminance value, as the luminance difference.

The change amount calculation unit 123 is configured to calculate a change amount of the luminance between images, from a plurality of images of the user captured at different timings. The change amount calculating unit 123 may calculate the change amount of the luminance, for example, by calculating the luminance difference between two images. The change amount calculation unit 123 may also calculate the change amount of the luminance, from three or more images.

### (Flow of Operation)

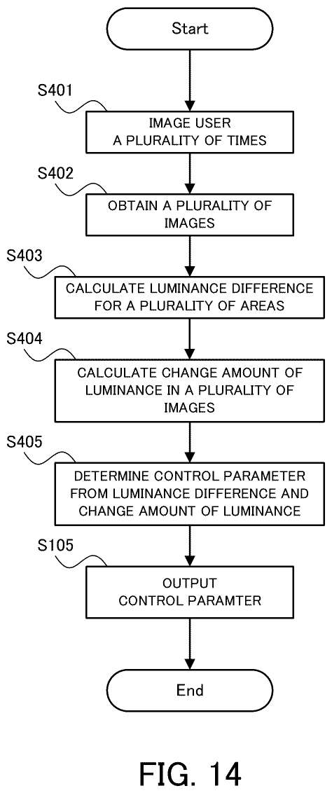

Next, with reference to FIG. 14, a flow of operation of the control apparatus 10 according to the seventh example embodiment will be described. FIG. 14 is a flowchart illustrating the flow of the operation of the control apparatus according to the seventh example embodiment. In FIG. 14, the same steps as those illustrated in FIG. 3 carry the same reference numerals.

As illustrated in FIG. 14, in operation of the control apparatus 10 according to the seventh example embodiment, first, the camera 18 captures the face image of the user a plurality of times at different timings (step S401). Then, the image acquisition unit 110 obtains a plurality of face images of the user captured by the camera 18 (step S402).

Subsequently, the luminance difference calculation unit 122 calculates the luminance difference for each of the plurality of areas in the face area, from the face images of the user captured by the image acquisition unit 110 (step S403). The luminance difference calculation unit 122 may calculate the luminance difference for all of the plurality of face images, or may calculate the luminance difference for a part of the face images (e.g., only a single image).

Subsequently, the change amount calculation unit 123 calculates the change amount of the luminance between images, from the plurality of face images of the user captured by the image acquisition unit 110 (step S404). The change amount calculation unit 123 may calculate the change amount of the luminance for each of the plurality of areas, may calculate the change amount of the luminance difference calculated by the luminance difference calculation unit 122, or may calculate both the change amounts.

Subsequently, the control parameter output unit 130 determines the control parameter to be outputted, on the basis of the luminance difference calculated by the luminance difference calculation unit 122 and the change amount calculated by the change amount calculation unit 123 (step S405). Then, the control parameter output unit 130 outputs the determined control parameters (step S105). A specific example of a method of determining the control parameter will be described in detail in an eighth example embodiment described later.

### (Calculation Example of Luminance Difference)

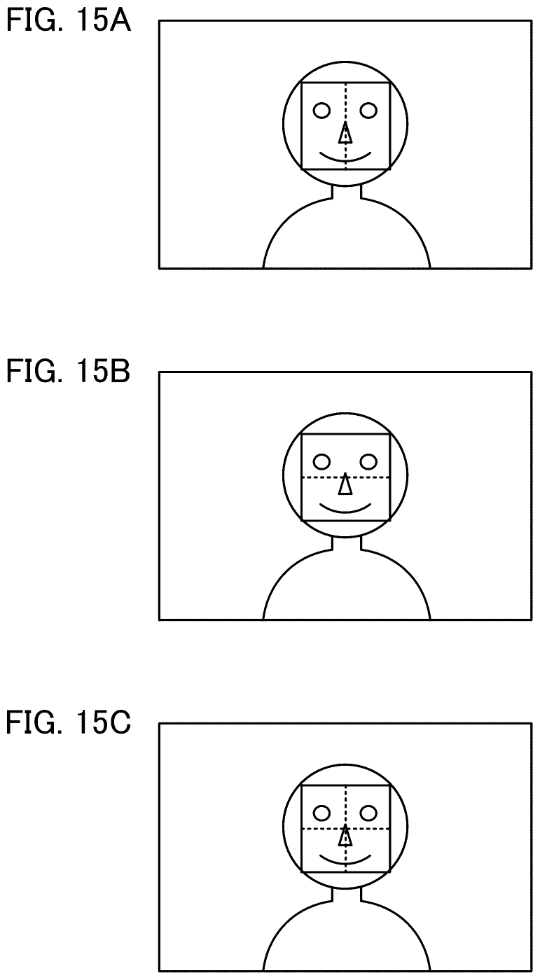

Next, an example of the calculation of the luminance difference by the luminance difference calculation unit 122 will be described with reference to FIG. 15A to FIG. 15C. FIG. 15A to FIG. 15C are plan views illustrating the example of the calculation of the luminance difference in the control apparatus according to the seventh example embodiment.

As illustrated in FIG. 15A, the luminance difference calculation unit 122 may divide the luminance detection area into two left and right parts, and may make a determination based on the luminance difference between the two areas. In this way, it is possible to detect a situation where only one of the left and right sides of the face is brightened (so-called oblique light).

As illustrated in FIG. 15B, the luminance difference calculation unit 122 may divide the luminance detection area into two upper and lower parts, and may make a determination based on the luminance difference between the two areas. In this way, it is possible to detect a situation where only one of the upper and lower sides of the face is brightened (e.g., a situation where the user wears a hat with a brim and a part of the face is shaded).

As illustrated in FIG. 15C, the luminance difference calculation unit 122 may divide the luminance detection area into four upper, lower, left and right parts, and may make a determination based on the luminance difference among the four areas. In this way, it is possible to detect the deviation of the brightness, more finely, as compared with the case of the division by two.

The above divided areas are merely an example, and the division may be performed in another aspect. For example, the face area may be divided into more areas (e.g., 5 or more). In addition, the face area may be divided into areas of different shapes.

### (Calculation Example of Change Amount)

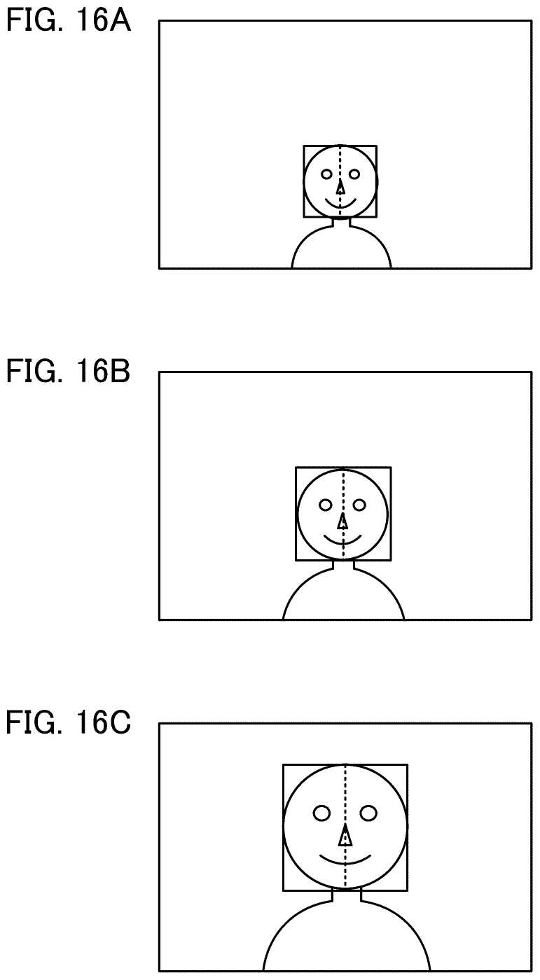

Next, an example of the calculation of the change amount by the change amount calculating unit 123 e will be described with reference to FIG. 16A to FIG. 16C. FIG. 16A to FIG. 16C are plan views illustrating the example of the calculation of the change amount of luminance in the control apparatus according to the seventh example embodiment.

As illustrated in FIG. 16A to FIG. 16C, the change amount calculation unit 123 may calculate the change amount of the luminance from the plurality of face images of the user captured at different timings. The example illustrated in FIG. 16A to FIG. 16C is images captured when the user approaches the camera 18 (e.g., images captured in walk-through authentication). FIG. 16A is an image captured when the user is far from the camera 18, FIG. 16B is an image when the user slightly approaches the camera 18 from the position where FIG. 16A is captured, and FIG. 16C is an image when the user further approaches the camera 18 from the position where FIG. 16B is captured.

When three images as described above are captured, the change amount calculation unit 123 may calculate the change amount of the luminance from all the images of FIG. 16A, FIG. 16B, and FIG. 16C. Alternatively, the change amount calculating unit 123 may calculate the change amount of the luminance from two images of FIG. 16A and FIG. 16B, FIG. 16A and FIG. 16c, and FIG. 16B and FIG. 16C. Here, described is the example in which three images are used, but the change amount calculation unit 123 may calculate the change amount of the luminance from four or more images.

### (Technical Effect)

Next, a technical effect obtained by the control apparatus 10 according to the seventh example embodiment will be described.

As described in FIG. 13 to FIG. 16C, in the control apparatus 10 according to the seventh example embodiment, the control parameter is determined and outputted, on the basis of the luminance difference for each of the plurality of areas and the change amount of the luminance in the plurality of face images. In this way, even when the luminance varies depending on imaging timing, it is possible to output an appropriate control parameter. For example, when a walking user is imaged, it is likely that the luminance of the image changes depending on a positional relationship between the user and the lighting 19, and that the face image cannot be captured in an appropriate imaging environment depending on the imaging timing. According to the control apparatus 10 in this example embodiment, however, the change amount of the luminance due to the imaging timing is considered, and it is thus possible to properly control the lighting 19, thereby to realize a better imaging environment.

### Eighth Example Embodiment

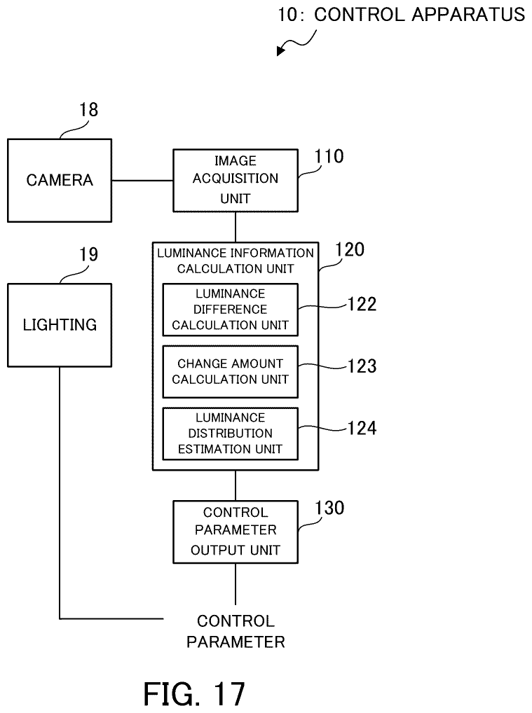

The control apparatus 10 according to an eighth example embodiment will be described with reference to FIG. 17 to FIG. 19. The eighth example embodiment is partially different from the seventh example embodiment only in the configuration and operation, and may be the same as t the first to seventh example embodiments in the other parts. For this reason, a part that is different from each of the example embodiments described above will be described in detail below, and a description of other overlapping parts will be omitted as appropriate.

### (Functional Configuration)

First, with reference to FIG. 17, a functional configuration of the control apparatus 10 according to the eighth example embodiment will be described. FIG. 17 is a block diagram illustrating the functional configuration of the control apparatus according to the eighth example embodiment. In FIG. 17, the same components as those illustrated in FIG. 13 carry the same reference numerals.

As illustrated in FIG. 17, the control apparatus 10 according to the eighth example embodiment includes, as process blocks for realizing the functions thereof, the image acquisition unit 110, the luminance information calculation unit 120, and the control parameter output unit 130. In particular, the luminance information calculation unit 120 according to the eighth example embodiment further includes a luminance distribution estimation unit 124, in addition to the luminance difference calculation unit 122 and the change amount calculation unit 123 described in the seventh example embodiment.

The luminance distribution estimation unit 124 is configured to estimate a luminance distribution of an image for authentication, on the basis of the change amount of the luminance calculated by the change amount calculation unit 123 (specifically, the change amount of the luminance between images, in a plurality of face images captured at different timings). Here, the “image for authentication” is the face image used for the authentication process of the user (e.g., face authentication), and is captured at slower timing than that of the plurality of face images obtained to calculate the change amount. The luminance distribution estimation unit 124 is configured to estimate the luminance distribution of the image for authentication, before capturing the image for authentication. The luminance distribution estimation unit 124 may estimate the luminance distribution of the entire image for authentication, or may estimate the luminance distribution of only a part (e.g., the face area, etc.) used for authentication. A detailed description of a specific method of estimating the luminance distribution will be omitted here, because the existing techniques/technologies can be adopted to the method as appropriate. Information about the luminance distribution of the image for authentication estimated by the luminance distribution estimation unit 124 is configured to be outputted to the control parameter output unit 130.

### (Flow of Operation)

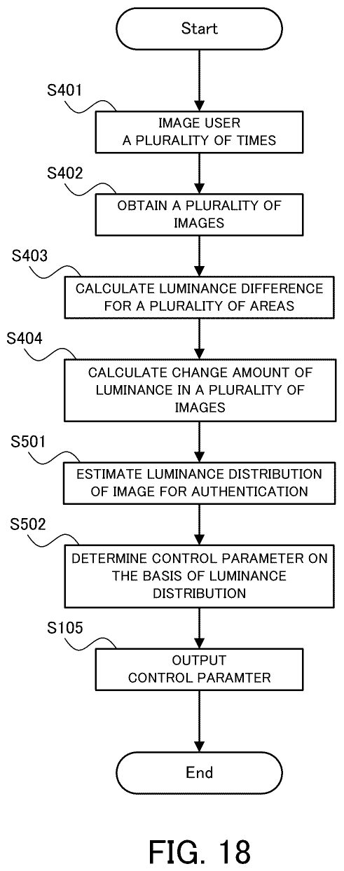

Next, with reference to FIG. 18, a flow of operation of the control apparatus 10 according to the eighth example embodiment will be described. FIG. 18 is a flowchart illustrating the flow of the operation of the control apparatus according to the eighth example embodiment. In FIG. 18, the same steps as those illustrated in FIG. 14 carry the same reference numerals.

As illustrated in FIG. 18, in operation of the control apparatus 10 according to the eighth example embodiment, first, the camera 18 captures the face image of the user a plurality of times at different timings (step S401). Then, the image acquisition unit 110 obtains a plurality of face images of the user captured by the camera 18 (step S402).

Subsequently, the luminance difference calculation unit 122 calculates the luminance difference for each of the plurality of areas in the face area, from the face images of the user captured by the image acquisition unit 110 (step S403). Subsequently, the change amount calculation unit 123 calculates the change amount of the luminance between images, from the plurality of face images of the user captured by the image acquisition unit 110 (step S404).

Subsequently, the luminance distribution estimation unit 124 estimates the luminance distribution of the image for authentication, on the basis of the change amount of the luminance calculated by the change amount calculation unit 123 (step S501). Then, the control parameter output unit 130 determines the control parameter, on the basis of the luminance distribution estimated by the luminance distribution estimation unit 124 (step S502). For example, the control parameter output unit 130 sets the control parameter such that the luminance distribution of the image for authentication is suitable for the authentication (in other words, the imaging environment for capturing the image for authentication is appropriate). Then, the control parameter output unit 130 outputs the determined control parameters (step S105).

### (Estimation Example of Luminance Distribution)

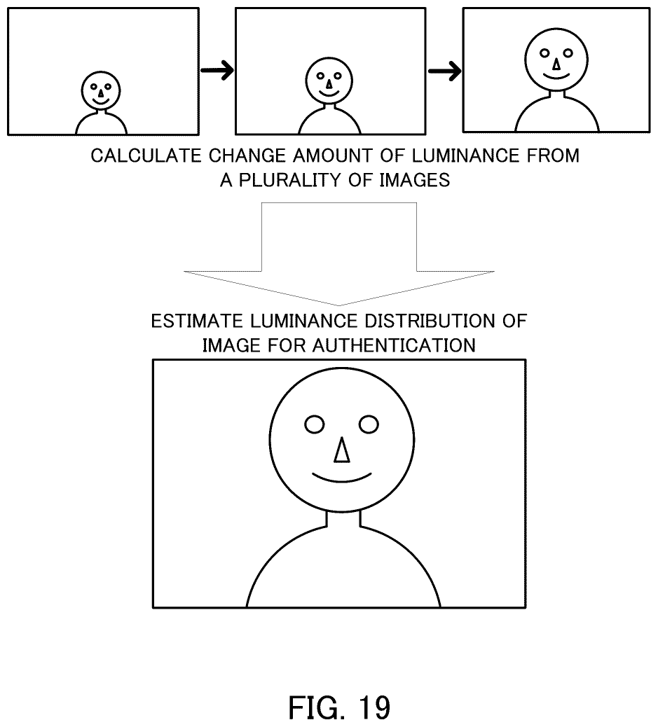

Next, an estimation example of the luminance distribution by the luminance distribution estimation unit 124 will be described with reference to FIG. 19. FIG. 19 is a conceptual diagram illustrating the estimation example of the luminance distribution in the control apparatus according to the eighth example embodiment.

In the example illustrated in FIG. 19, a plurality of images are captured in a situation where the user approaches the camera 18. In this case, first, the change amount calculation unit 123 calculates the change amount of the luminance from the plurality of face images. Specifically, calculated is information indicating how the luminance of the face images changes as the user approaches the camera 18.

Then, the luminance distribution estimation unit 124 estimates the luminance distribution of the image for authentication, on the basis of the calculated change amount of the luminance. Specifically, the luminance distribution estimation unit 124 estimates the luminance distribution of the face image when the user approaches a position where the image for authentication is captured (i.e., at the timing that is later than the timing at which the image used to calculate the change amount of the luminance is captured). For example, when it is seen from the change amount that the luminance increases as the user approaches the camera 18, the luminance distribution estimation unit 124 may estimate that the luminance distribution of the image for authentication further increases. In addition, when it is seen from the change amount that the luminance decreases as the user approaches the camera 18, the luminance distribution estimation unit 124 may estimate that the luminance distribution of the image for authentication further decreases.

### (Technical Effect)

Next, a technical effect obtained by the control apparatus 10 according to the eighth example embodiment will be described.

As described in FIG. 17 to FIG. 19, in the control apparatus 10 according to the eighth example embodiment, the luminance distribution of the image for authentication is estimated on the basis of the change amount of the luminance calculated from the plurality of face images. In this way, even when the luminance varies depending on the imaging timing, the luminance distribution of the image for authentication can be known in advance, and it is thus possible to output an appropriate control parameter in order to capture the image for authentication.

### Ninth Example Embodiment

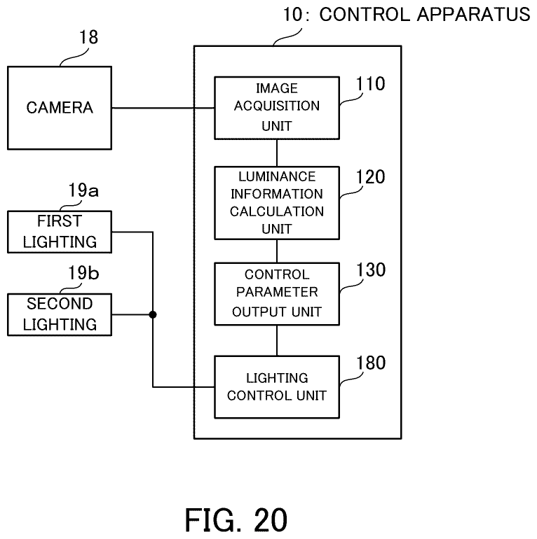

The control apparatus 10 according to a ninth example embodiment will be described with reference to FIG. 20 to FIG. 22. The ninth example embodiment is partially different from the first to eighth example embodiments only in the configuration and operation, and may be the same as the first to eighth example embodiments in the other parts. For this reason, a part that is different from each of the example embodiments described above will be described in detail below, and a description of other overlapping parts will be omitted as appropriate.

### (Functional Configuration)

First, with reference to FIG. 20, a functional configuration of the control apparatus 10 according to the ninth example embodiment will be described. FIG. 20 is a block diagram illustrating the functional configuration of the control apparatus according to the ninth example embodiment. In FIG. 20, the same components as those illustrated in FIG. 2 carry the same reference numerals.

As illustrated in FIG. 20, the control apparatus 10 according to the ninth example embodiment is connected to the camera 18, a first lighting 19a, and a second lighting 19b. The control apparatus 10 according to the ninth example embodiment includes, as process blocks for realizing the functions thereof, the image acquisition unit 110, the luminance information calculation unit 120, the control parameter output unit 130, and a lighting control unit 180. That is, the control apparatus 10 according to the ninth example embodiment includes the lighting control unit 180, in addition to the configuration in the first example embodiment (see FIG. 2). The lighting control unit 180 may be realized or implemented by the processor (see FIG. 1).

The lighting control unit 180 is configured to control the lightings 19 (here, the first lighting 19a and the second lighting 19b). Specifically, the lighting control unit 180 is configured to adjust the illuminance and the direction of the lightings 19, on the basis of the control parameter outputted from the control parameter output unit 130.

The first lighting 19a and the second lighting 19b are configured to apply illumination lights to a single common user at the same time. The first irradiation 19a and the second lighting 19b may be disposed at a position where the user can be irradiated with the illumination lights from different angles. Here, described is the example in which the number of the lightings 19 is two, but a larger number of lightings 19 (i.e., three or more lightings) may be controllable.

### (Flow of Operation)

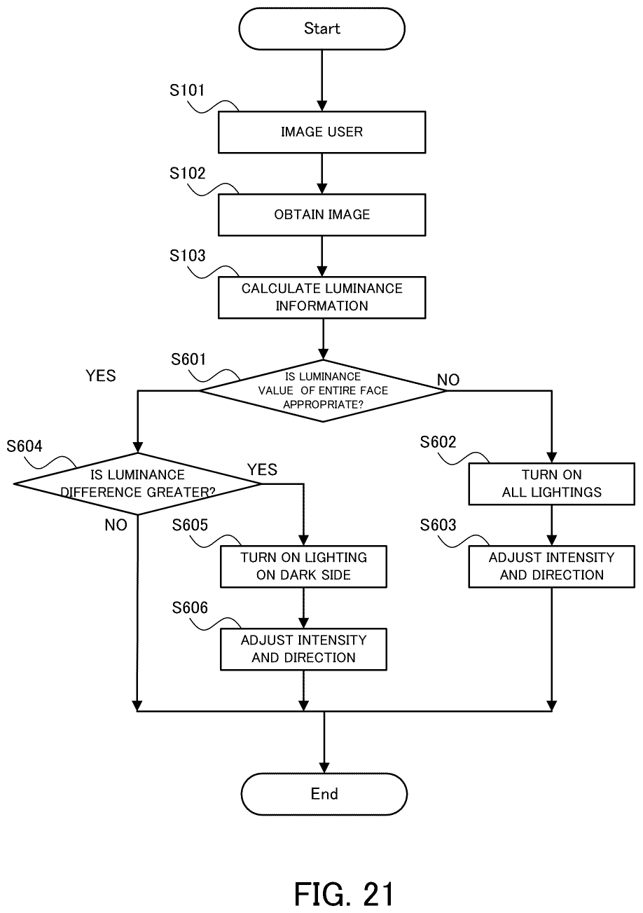

Next, with reference to FIG. 21, a flow of operation of the control apparatus 10 according to the ninth example embodiment will be described. FIG. 21 is a flowchart illustrating the flow of the operation of the control apparatus according to the ninth example embodiment. In FIG. 21, the same steps as those illustrated in FIG. 3 carry the same reference numerals.

As illustrated in FIG. 21, in operation of the control apparatus 10 according to the ninth example embodiment, first, the camera 18 captures the face image of the user (step S101). The image acquisition unit 110 obtains the face image of the user captured by the camera 18 (step S102). When the image is captured for the first time, both the first lighting 19a and the second lighting 19b are turned off.

Subsequently, the luminance information calculation unit 120 calculates the luminance information for each of the plurality of areas in the face area, from the face image of the user captured by the image acquisition unit 110 (step S103). Then, the control parameter output unit 130 determines whether or not the luminance value of the entire face (e.g., the average luminance value of the entire face) satisfies a predetermined condition (step S601).

Here, when it is determined that the luminance value of the entire face does not satisfy the predetermined condition (step S601: NO), it can be determined that the face of the user is dark as a whole. Therefore, the control parameter output unit 130 outputs the control parameter that allows the imaging environment to brighten. Consequently, the lighting control unit 180 controls both the first lighting 19a and the second lighting 19b to be turned on (step S602). Then, the lighting control unit 180 adjusts the intensity and direction of the first lighting 19a and the second lighting 19b at appropriate values (step S603).

On the other hand, when it is determined that the luminance value of the entire face satisfies the predetermined condition (step S601: YES), it can be determined that the brightness of the face of the user is not problematic as a whole. In this case, the control parameter output unit 130 determines whether or not the luminance difference of the plurality of divided areas is greater than a predetermined threshold (step S604). When it is determined that the luminance difference of the plurality of divided areas is not greater than the predetermined threshold (step S604: NO), it can be determined that the brightness of the face of the user is not problematic even in each of the divided areas. Therefore, in this case, the control parameter output unit 130 does not output the control parameter, or outputs the control parameter for maintaining a current situation. Consequently, the control of the lightings 19 is not performed, and a series of processing steps are ended.

On the other hand, when it is determined that the luminance difference of the plurality of divided areas is greater than the predetermined threshold (step S604: YES), it can be determined that only one area side is dark. In this case, the control parameter output unit 130 outputs the control parameter for brightening the dark area. Consequently, lighting control unit 180 controls the dark side of the first lighting 19a and the second lighting 19b to be turned on (step S605). The lighting control unit 180 adjusts the intensity and direction of one of the first lighting 19a and the second lighting 19b that is turned on, at appropriate values (step S606).

### (Specific Control Example)

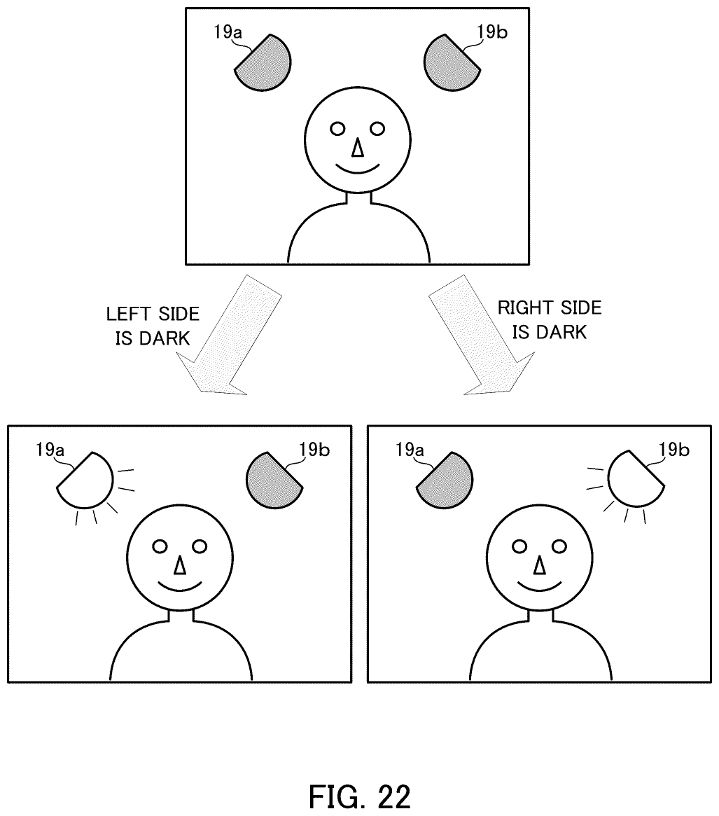

Next, with reference to FIG. 22, a specific control example of the lightings 19 by the control apparatus 10 according to the ninth example embodiment will be described. FIG. 22 is a conceptual diagram illustrating the control example of the lighting by the control apparatus according to the ninth example embodiment.

As illustrated in FIG. 22, it is assumed that there are provided the lighting 19a that illuminates the left side of the user when viewed from the camera 18 and the lighting 19b that illuminates the right side of the user. In such a case, when it is determined that the left side of the face of the user is dark, the lighting control unit 180 turns on the lighting 19a that illuminates the left side of the user. In this way, the left side of the user is brighter than before lighting, and the brightness of the face of the user is appropriate on both the right and left sides. On the other hand, when it is determined that the right side of the face of the user is dark, the lighting control unit 180 turns on the lighting 19b that illuminates the right side of the user. In this way, the right side of the user is brighter than before lighting, and the brightness of the face of the user is appropriate on both the right and left sides.

### (Technical Effect)

Next, a technical effect obtained by the control apparatus 10 according to the ninth example embodiment will be described.

As described in FIG. 20 to FIG. 22, in the control apparatus 10 according to the ninth example embodiment, the plurality of lightings 19 are separately controlled in accordance with the luminance distribution of the face of the user (i.e., the luminance of the entire face area, the luminance difference of the plurality of areas, etc.). In this way, the control of the lightings 19 makes it possible to improve the imaging environment more properly. Specifically, for example, even when the brightness of the face of the user is biased, it is possible to properly eliminate the bias in the brightness, by controlling only a part of the lightings 19.

### Tenth Example Embodiment

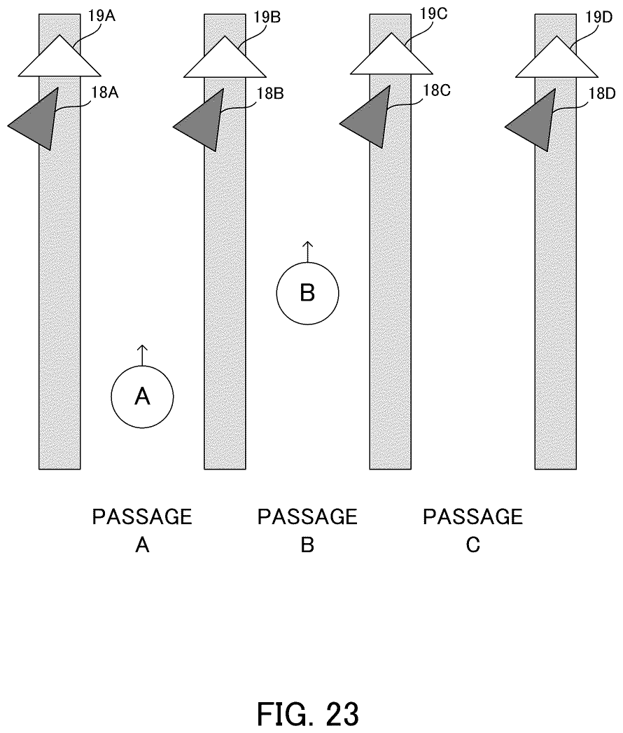

The control apparatus 10 according to a tenth example embodiment will be described with reference to FIG. 23. The tenth example embodiment is partially different from the first to ninth example embodiments only in the configuration and operation, and may be the same as the first to ninth example embodiments in the other part. For this reason, a part that is different from each of the example embodiments described above will be described in detail below, and a description of other overlapping parts will be omitted as appropriate.

### (Configuration of Apparatus)

First, with reference to FIG. 23, a configuration of the control apparatus 10 according to the eighth example embodiment will be described. FIG. 23 is a plan view illustrating the configuration and an operation example of the control apparatus according to the tenth example embodiment.

As illustrated in FIG. 23, the control apparatus 10 according to the tenth example embodiment is applied to a system in which the faces of users walking through a plurality of passages are imaged by a plurality of cameras 18A, 18B, 18C, and 18D and the face authentication based on the face images is performed.

Between the passages, there are provided a plurality of lightings 19A, 19B, 19C, and 19D. Each of the lightings 19A, 19B, 19C and 19D is configured to apply an illumination light to users walking through adjacent passages. Specifically, a user walking through a passage A is irradiated with illumination lights from the lightings 19A and 19B. A user walking through a passage B is irradiated with illumination lights from the lightings 19B and 19C. A user walking through a passage C is irradiated with illumination lights from the lightings 19C and 19D.

As described above, in the system to which the control apparatus 10 according to the tenth example embodiment is applied, the plurality of lightings 19A, 19B, 19C, and 19D may be shared by a plurality of users (i.e., a single lighting 19 may influence a plurality of users). For this reason, the lightings 19A, 19B, 19C and 19D are configured to be cooperatively controllable, on the basis of information about a plurality of users.

### (Specific Operation Example)

With reference to FIG. 23, a specific operation example of the control apparatus 10 according to the tenth example embodiment will be described.

As illustrated in FIG. 23, it is assumed that the user A is walking through the passage A and the user B is walking through the passage B. In this case, the user A is irradiated with the illumination lights from the lightings 19A and 19B. In addition, the user B is irradiated with the illumination lights from the lightings 19B and 19C. Therefore, the illumination light of the lighting 19B is applied to both the user A and the user B.

In this case, first, the control parameter output unit 130 outputs the control parameter for fixing the illumination of the lighting 19B that influences both the user A and the user B. Consequently, the lighting control unit 180 controls the brightness of the lighting 19B to be fixed in predetermined brightness. The other lightings 19A and 19C may be turned off at this point, or may be controlled to have the same predetermined brightness as that of the lighting 19B.

Then, the control parameter output unit 130 outputs the control parameter related to the lighting 19A, on the basis of the luminance information about the face image of the user after controlling the lighting 19B. Consequently, the lighting control unit 180 controls the lighting 19A in accordance with the imaging environment of the user A, while fixing the lighting 19B. Specifically, the lighting control unit 180 controls only the brightness of the lighting 19A, while fixing the lighting 19B at the predetermined brightness, so that the imaging environment of the face image of the user A is appropriate.

Similarly, the control parameter output unit 130 outputs the control parameter related to the lighting 19C, on the basis of the luminance information about the face image of the user B after controlling the lighting 19B. Consequently, the lighting control unit 180 controls the lighting 19C in accordance with the imaging environment of the user B while fixing the lighting 19B. Specifically, the lighting control unit 180 controls only the brightness of the lighting 19C while fixing the lighting 19B at the predetermined brightness, so that the imaging environment of the face image of the user B is appropriate.

### (Technical Effect)

Next, a technical effect obtained by the control apparatus 10 according to the tenth example embodiment will be described.

As described in FIG. 23, in the control apparatus 10 according to the tenth example embodiment, the lightings 19 shared for a plurality of users is cooperatively controlled. In this way, even when a single lighting 19 influences a plurality of users, the brightness of the face of each user can be set appropriate.

### Eleventh Example Embodiment

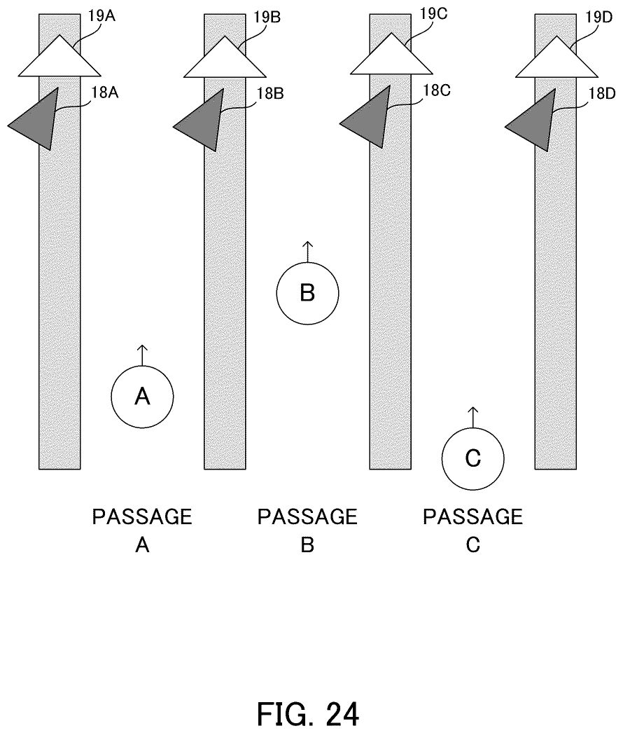

The control apparatus 10 according to an eleventh example embodiment will be described with reference to FIG. 24. The control apparatus 10 according to the eleventh example embodiment is partially different from the tenth example embodiment only in operation, and may be the same as the tenth example embodiment in the other parts. For this reason, a part that is different from each of the example embodiments described above will be described in detail below, and a description of other overlapping parts will be omitted as appropriate.

### (Specific Operation Example)

First, with reference to FIG. 24, a specific operation example of the control apparatus 10 according to the eleventh example embodiment will be described. FIG. 24 is a plan view illustrating a configuration and the operation example of the control apparatus according to the eleventh example embodiment.

As illustrated in FIG. 24, it is assumed that the user A is walking on the passage A, the user B is walking on the passage B, and the user C is walking on the passage C. In this case, the user A is irradiated with the illumination lights from the lightings 19A and 19B. The user B is irradiated with the illumination lights from the lightings 19B and 19C. The user C is irradiated with the illumination lights from the lightings 19C and 19D.

When there are users in both adjacent passages in this manner, first, the control parameter output unit 130 outputs the control parameter for controlling the lightings 19 that influence the user B who is the closest to the camera 18. Thus, first, the lighting control unit 180 controls the lightings 19B and 19C that influence the user B, on the basis of the control parameter outputted for the user B.

Then, the control parameter output unit 130 outputs the control parameters for controlling the lightings 19 that influence the other users (the user A and the user C), on condition that the imaging of the face image of the user B is completed (specifically, on condition that the image that is not problematic for performing the face authentication is captured). Thus, the lighting control unit 180 controls the lightings 19A and 19B that influence the user A, on the basis of the control parameter outputted for the user A. The lighting control unit 180 also controls the lightings 19C and 19D that influence the user C, on the basis of the control parameter outputted for the user C.

### (Technical Effect)

Next, a technical effect obtained by the control apparatus 10 according to the eleventh example embodiment will be described.

As described in FIG. 24, in the control apparatus 10 according to the eleventh example embodiment, the lightings 19 are controlled on the basis of the distance between the users and the respective cameras 18. In this way, even when there are users in adjacent passages, the lightings 19 are sequentially controlled in accordance with the user who is closer to respective one of the cameras 18 (i.e., the user for whom the authentication process is performed at earlier timing). Therefore, the brightness of the face of each user in the face authentication can be set appropriate.

### Twelfth Example Embodiment

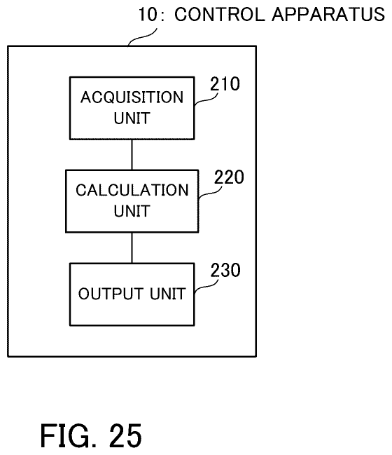

The control apparatus 10 according to a twelfth example embodiment will be described with reference to FIG. 25. The control apparatus 10 according to the twelfth example embodiment is partially different from the first to eleventh example embodiments only in the configuration and operation, and may be the same as the first to eleventh example embodiments in the other parts. For this reason, a part that is different from each of the example embodiments described above will be described in detail below, and a description of other overlapping parts will be omitted as appropriate.

### (Configuration and Operation)

First, with reference to FIG. 25, the control apparatus 10 according to the twelfth example embodiment will be described. FIG. 25 is a block diagram illustrating a configuration of the control apparatus 10 according to the twelfth example embodiment.

As illustrated in FIG. 25, the control apparatus 10 includes an acquisition unit 210, a calculation unit 220, and an output unit 230. The acquisition unit 210 obtains the face image including the face area of the authentication target. The calculation unit 220 calculates the luminance information of each of the plurality of areas in the face area. The output unit 230 outputs the control parameter for controlling a lighting device that applies an illumination light when the face image is captured, on the basis of the information about the luminance.

### (Technical Effect)

Next, a technical effect obtained by the control apparatus 10 according to the twelfth example embodiment will be described.

In the control apparatus 10 according to the twelfth example embodiment, the control parameter for controlling the lighting is outputted on the basis of the luminance information calculated for each of the plurality of areas in the face area. In this way, the control of the lighting according to the control parameter makes it possible to improve the imaging environment of the image of the user.

Therefore, for example, the face of the user authentication can be properly performed.

A process method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes process alone, but also the program that operates on an OS and executes process in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. A control apparatus, a control method, and a recording medium with such changes are also intended to be within the technical scope of this disclosure.

### SUPPLEMENTARY NOTES

The example embodiments described above may be further described as, but not limited to, the following Supplementary Notes below.

### Supplementary Note 1

A control apparatus according to Supplementary Note 1 is a control apparatus including: an acquisition unit that obtains a face image including a face area of an authentication target; a calculation unit that calculates information about luminance of each of a plurality of areas in the face area; and an output unit that outputs a control parameter for controlling a lighting unit that applies an illumination light when the face image is captured, on the basis of the information about the luminance.

### Supplementary Note 2

A control apparatus according to Supplementary Note 2 is the control apparatus according to Supplementary Note 1, further including: an information acquisition unit that obtains information about the authentication target; and a storage unit that stores the control parameter in association with a predetermined group corresponding to the information about the authentication target, wherein the output unit outputs the control parameter as a control parameter corresponding to a new authentication target, when the control parameter is stored in association with a group corresponding to the information about the authentication target obtained from the new authentication target.

### Supplementary Note 3

A control apparatus according to Supplementary Note 3 is the control apparatus according to Supplementary Note 1 or 2, further including: a detection unit that detects an eye color of the authentication target; and a range setting unit that sets a range of the control parameter to be calculated, to a first range, when the eye color is brighter than a predetermined threshold, and sets the range of the control parameter to be calculated, to a second range that is different from the first range, when the eye color is darker than the predetermined threshold, wherein the output unit determines and outputs the control parameter to be in the range set by the range setting unit.

### Supplementary Note 4

A control apparatus according to Supplementary Note 4 is the control apparatus according to any one of Supplementary Notes 1 to 3, wherein the acquisition unit obtains a plurality of face images at different timings for one authentication target, the calculation unit calculates, as the information about the luminance, a difference in the luminance for each of the plurality of areas, and a change amount of the luminance between images in a plurality of face images, and the output unit outputs the control parameter on the basis of the difference in the luminance and the change amount of the luminance.

### Supplementary Note 5

A control apparatus according to Supplementary Note 5 is the control apparatus according to Supplementary Note 4, wherein before an image for authentication used in authentication of the authentication target is captured, the calculation unit estimates a luminance distribution of the image for authentication, on the basis of the difference in the luminance and the change amount of the luminance, and the output unit outputs the control parameter on the basis of the estimated luminance distribution of the image for authentication.

### Supplementary Note 6

A control apparatus according to Supplementary Note 6 is the control apparatus according to any one of Supplementary Notes 1 to 5, wherein the lighting unit includes: a first lighting corresponding to the authentication target passing through a first passage, a second lighting corresponding to the authentication target passing through the first passage and the authentication target passing through a second passage, and a third lighting corresponding to the authentication target passing through the second passage and the authentication target passing through a third passage, and the control apparatus further includes an adjustment unit that fixes illuminance of the second lighting and adjusts illuminance of the first lighting and the third lighting, when there are the authentication targets on the first passage and the second passage at the same time.

### Supplementary Note 7

A control apparatus according to Supplementary Note 7 is the control apparatus according to any one of Supplementary Notes 1 to 5, wherein the lighting unit includes: a first lighting corresponding to the authentication target passing through a first passage, a second lighting corresponding to the authentication target passing through the first passage and the authentication target passing through a second passage, and a third lighting corresponding to the authentication target passing through the second passage and the authentication target passing through a third passage, and the control apparatus further includes a control unit that controls at least two of the first lighting, the second lighting, and the third lighting, in accordance with the authentication target who is close to an imaging unit that captures the face image, when there are the authentication targets on the first passage and the second passage at the same time, and that controls at least two of the first lighting, the second lighting, and the third lighting, in accordance with the authentication target who is far from the imaging unit that captures the face image, after the face image of the authentication target who is close to the imaging unit is captured.

### Supplementary Note 8

A control method according to Supplementary Note 8 is a control method executed by at least one computer, the control method including: obtaining a face image including a face area of an authentication target; calculating information about luminance of each of a plurality of areas in the face area; and outputting a control parameter for controlling a lighting unit that applies an illumination light when the face image is captured, on the basis of the information about the luminance.

### Supplementary Note 9

A recording medium according to Supplementary Note 9 is a recording medium on which a computer program that allows at least one computer to execute a control method is recorded, the control method including: obtaining a face image including a face area of an authentication target; calculating information about luminance of each of a plurality of areas in the face area; and outputting a control parameter for controlling a lighting unit that applies an illumination light when the face image is captured, on the basis of the information about the luminance.

### Supplementary Note 10

A computer program according to Supplementary Note 10 is a computer program that allows at least one computer to execute a control method, the control method including: obtaining a face image including a face area of an authentication target; calculating information about luminance of each of a plurality of areas in the face area; and outputting a control parameter for controlling a lighting unit that applies an illumination light when the face image is captured, on the basis of the information about the luminance.

### DESCRIPTION OF REFERENCE CODES

10 Control apparatus
11 Processor
18 Camera
19 Lighting
110 Image acquisition unit
120 Luminance information calculation unit
121 Image analysis unit
1211 Face area detection unit
1212 Luminance value detection unit
122 Luminance difference calculation unit
123 Change amount calculation unit
124 Luminance distribution estimation unit
130 Control parameter output unit
131 Analysis result acquisition unit
132 Environment determination unit
133 Environment information storage unit
140 Target information acquisition unit
150 Parameter storage unit
160 Eye color detection unit
170 Range setting section
180 Lighting control unit
200 Face authentication apparatus
210 Acquisition unit
220 Calculation unit
230 Output unit

What is claimed is:

1. A control apparatus comprising:
at least one memory that is configured to store instructions; and
at least one processor that is configured to execute the instructions to
obtain a face image including a face area of an authentication target;
calculate information about luminance of each of a plurality of areas in the face area; and
output a control parameter for controlling a lighting unit that applies an illumination light when the face image is captured, on the basis of the information about the luminance.

2. The control apparatus according to claim 1, wherein the at least one processor is configured to execute the instructions to:
obtain information about the authentication target;
store the control parameter in association with a predetermined group corresponding to the information about the authentication target, and
output the control parameter as a control parameter corresponding to a new authentication target, when the control parameter is stored in association with a group corresponding to the information about the authentication target obtained from the new authentication target.

3. The control apparatus according to claim 1, wherein the at least one processor is configured to execute the instructions to:
detect an eye color of the authentication target;
set a range of the control parameter to be calculated, to a first range, when the eye color is brighter than a predetermined threshold, and sets the range of the control parameter to be calculated, to a second range that is different from the first range, when the eye color is darker than the predetermined threshold, and
determine and output the control parameter to be in the range set.

4. The control apparatus according to claim 1, wherein
the at least one processor is configured to execute the instructions to obtain a plurality of face images at different timings for one authentication target,
calculate, as the information about the luminance, a difference in the luminance for each of the plurality of areas, and a change amount of the luminance between images in a plurality of face images, and
output the control parameter on the basis of the difference in the luminance and the change amount of the luminance.

5. The control apparatus according to claim 4, wherein
before an image for authentication used in authentication of the authentication target is captured, the at least one processor is configured to execute the instructions to estimate a luminance distribution of the image for authentication, on the basis of the difference in the luminance and the change amount of the luminance, and
the at least one processor is configured to execute the instructions to output the control parameter on the basis of the estimated luminance distribution of the image for authentication.

6. The control apparatus according to claim 1, wherein
the lighting unit includes: a first lighting corresponding to the authentication target passing through a first passage, a second lighting corresponding to the authentication target passing through the first passage and the authentication target passing through a second passage, and a third lighting corresponding to the authentication target passing through the second passage and the authentication target passing through a third passage, and
the at least one processor is configured to execute the instructions to fix illuminance of the second lighting and adjusts illuminance of the first lighting and the third lighting, when there are the authentication targets on the first passage and the second passage at the same time.

7. The control apparatus according to claim 1, wherein
the lighting unit includes: a first lighting corresponding to the authentication target passing through a first passage, a second lighting corresponding to the authentication target passing through the first passage and the authentication target passing through a second passage, and a third lighting corresponding to the authentication target passing through the second passage and the authentication target passing through a third passage, and
the at least one processor is configured to execute the instructions to control at least two of the first lighting, the second lighting, and the third lighting, in accordance with the authentication target who is close to an imaging unit that captures the face image, when there are the authentication targets on the first passage and the second passage at the same time, and control at least two of the first lighting, the second lighting, and the third lighting, in accordance with the authentication target who is far from the imaging unit that captures the face image, after the face image of the authentication target who is close to the imaging unit is captured.

8. A control method executed by at least one computer, the control method comprising:
obtaining a face image including a face area of an authentication target;
calculating information about luminance of each of a plurality of areas in the face area; and
outputting a control parameter for controlling a lighting unit that applies an illumination light when the face image is captured, on the basis of the information about the luminance.

9. A non-transitory recording medium on which a computer program that allows at least one computer to execute a control method is recorded, the control method including:
obtaining a face image including a face area of an authentication target;
calculating information about luminance of each of a plurality of areas in the face area; and
outputting a control parameter for controlling a lighting unit that applies an illumination light when the face image is captured, on the basis of the information about the luminance.
